(19) United States
(12) Patent Application Publication
(10) Pub. No.: US 2007/0214979 A1
(43) Pub. Date: Sep. 20, 2007

(54) Dual-web satellite printing press

(75) Inventor: John Sheridan Richards, Barrington, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/375,319

(22) Filed: Mar. 14, 2006

(51) Int. Cl. B41F 5/18

(52) U.S. Cl. 101/181

(57) ABSTRACT

A web printing press includes a first satellite print unit printing a first web on a first web first side, a second satellite print unit printing a second web on a second web first side and a first dryer downstream of the first and second satellite print units, the first and second webs passing through the first dryer. A third satellite print unit prints the first web on a first web second side downstream of the first dryer, and a fourth satellite print unit prints the second web on a second web second side downstream of the first dryer. A method is also provided.

### FIELD OF THE INVENTION

The present invention relates generally to web printing presses and methods for operating such presses.

### BACKGROUND OF THE INVENTION

Web presses print on continuous rolls of paper or other substrates, often printing on both surfaces of the paper at the same time. A typical web press includes several print units for printing different colors of ink onto a web, as well as units for drying, cutting and folding the web.

Satellite printing presses are also known on which a first side of the web is printed, typically with four colors, using a satellite impression cylinder and four plate cylinders, each of which either directly contacts the web or contacts the web via a blanket cylinder. The web then is dried by a heatset drier, and then the second side is printed, also typically with four colors, using a satellite impression cylinder and four plate cylinders. The fully printed web then is dried with a second heatset drier.

The two dryers typically are required because after the first side is printed, the ink must set before the web is passed over the second satellite impression cylinder for the printing of the second side. If the ink were not set, the image on the first side of the web could smear or suffer other drawbacks.

Dryers are large devices which are expensive both from a capital investment standpoint and an operational standpoint, as their energy consumption is high. They also require long web leads.

U.S. Pat. No. 4,467,719 discloses a satellite printing press where the web is printed on one side, passed through a dryer, and then printed on another side, and then passed back again through the dryer in an opposite direction.

U.S. Pat. No. 4,467,719 and U.S. Pat. No. 5,778,779, also disclosing satellite printing presses, are hereby incorporated by reference herein.

### SUMMARY OF THE INVENTION

The present invention provides a web printing press comprising:
a first satellite print unit printing a first web on a first web first side;
a second satellite print unit printing a second web on a second web first side;
a first dryer downstream of the first and second satellite print units, the first and second webs passing through the first dryer;
a third satellite print unit printing the first web on a first web second side downstream of the first dryer; and
a fourth satellite print unit printing the second web on a second web second side downstream of the first dryer.

By passing two webs through one dryer, the dryer can dry both sides of two webs while they travel in a same direction.

Preferably, the first web second side and second web second side face each other passing through the first dryer section, so that the inked sides face away and can be more effectively dried.

After printing by the third and fourth satellite print units, a second dryer preferably is provided to set the ink on the first web second side and second web second side face.

The second dryer may be located next to the first dryer or separately.

The first dryer and second dryers preferably each include a chill section, for example chill rolls after a heating section.

Each satellite web print unit preferably is at least a four-color print unit.

The present invention also provides a method for printing dual webs comprising:
printing a first web on a first web first side;
printing a second web on a second web first side;
subsequently drying the first and second webs in a first dryer;
printing the first web on a first web second side downstream of the first dryer; and
printing the second web on a second web second side downstream of the first dryer.

### BRIEF DESCRIPTION OF THE DRAWINGS

Further objects, features and advantages of the present invention will become apparent from the following detailed description taken in conjunction with the accompanying figure, in which:

FIG. 1 illustrates a web printing press in accordance with an embodiment of the present invention.

### DETAILED DESCRIPTION

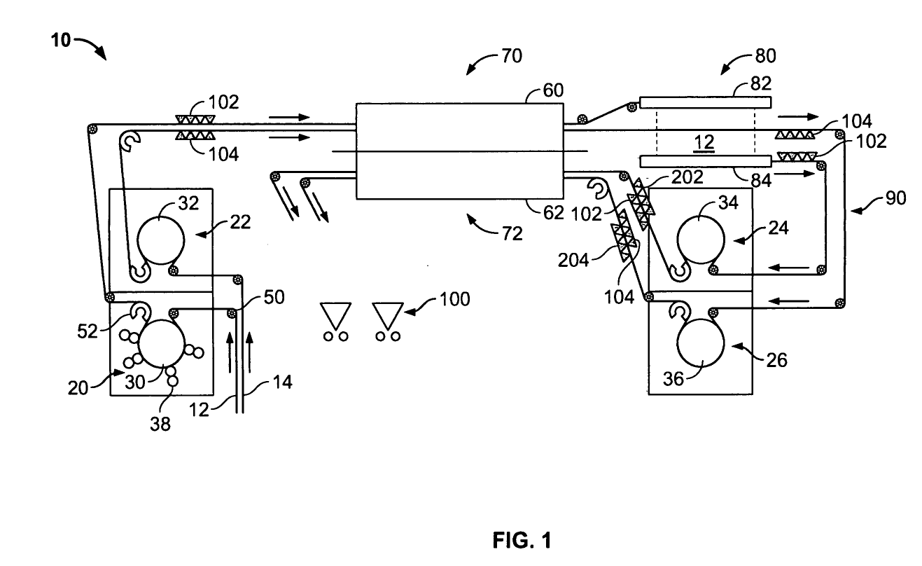

FIG. 1 shows a web printing press 10 including four print units 20, 22, 24, 26, each of which may has a satellite impression cylinder 30, 32, 34, 36, and four plate cylinder/blanket cylinder couples 38 for four color printing for each print unit 20, 22, 24, 26.

Print unit 20 prints four colors on a first side 102 of first web 12, and print unit 22 prints four colors in a first side 104 of web 14, as shown schematically. Prior to printing the web may be contacted by rollers 50. After printing and before drying, the wet web surfaces are typically directed by air bars 52 on the printed side, and rollers 50 on the unprinted or dried side. Air bars 52 provide an air cushion on their outer surface to prevent ink on the web from smearing.

Webs 12 and 14 are supplied to dryer 60 via guide rollers 50 and air bars 52. Dryer 60 includes a dryer portion for drying a moving web and a chill rolls portion to cool the moving web. The guide rollers, typically four, and air bars, typically five, guide webs 12, 14 so that they pass together in a same direction through dryer 60 with their printed sides 102, 104 facing outwardly and their unprinted sides facing each other as shown. This permits better drying of sides 102, 104.

Webs 12, 14 are subsequently moved through the chill portion 70 of dryer 60 in order to cool the heated webs 12, 14 and to help set the ink. A chill roll assembly typically includes a succession of rolls which are cooled by water or other coolant flowing through the interior of the rolls.

After moving through dryer 60, web 12 advances to web guiding device 80 which may include angle bars 82, 84 to bring web 12 inside web 14. At this stage, a configuration of various rollers and angle bars can be provided for example to provide a bay window 90 for controlling the direction and position of webs 12, 14. U.S. Pat. No. 6,902,135 for example is hereby incorporated by reference herein.

Print unit 24 then prints for example four colors on side 202 of web 12 opposite side 102, and print unit 26 prints on side 204 of web 14. When webs 12, 14 then may exit the print units 24, 26 respectively via air bars. Webs 12 and 14 then pass through a second dryer 62 with a chill section 72, so that preferably wet sides 202, 204 face outwardly, and dried sides 102, 104 face each other.

Webs 12, 14 may then pass to a folder section 100 for the two webs where each web 12, 14 may be slit, resultant ribbons may be combined, and the ribbons folded longitudinally and cut into signatures.

The print units 20, 22, 24, 26 may have horizontal web entry and exits.

What is claimed is:

1. A web printing press comprising:
a first satellite print unit printing a first web on a first web first side;
a second satellite print unit printing a second web on a second web first side;
a first dryer downstream of the first and second satellite print units, the first and second webs passing through the first dryer;
a third satellite print unit printing the first web on a first web second side downstream of the first dryer; and
a fourth satellite print unit printing the second web on a second web second side downstream of the first dryer.

2. The web printing press as recited in claim 1 wherein the first web second side and second web second side face each other passing through the first dryer.

3. The web printing press as recited in claim 1 further comprising a second dryer downstream of the third and fourth satellite print units.

4. The web printing press as recited in claim 1 wherein the first dryer includes a chill section.

5. The web printing press as recited in claim 1 wherein the first satellite print unit is at least a four-color print unit.

6. The web printing press as recited in claim 1 wherein the first satellite print unit has vertical web entry and exit points.

7. The web printing press as recited in claim 1 wherein the printing press is a newspaper printing press.

8. The web printing press as recited in claim 1 further comprising a web guiding device for the first web between the first dryer and the third satellite print unit.

9. The web printing press as recited in claim 8 wherein the web guiding device includes one or more angle bars and one or more rollers.

10. The web printing press as recited in claim 9 wherein the web guiding device provides a bay window for the first web.

11. The web printing press as recited in claim 2 wherein the first dryer is located directly above the second dryer.

12. A method for printing dual webs comprising:
printing a first web on a first web first side;
printing a second web on a second web first side;
subsequently drying the first and second webs in a first dryer;
printing the first web on a first web second side downstream of the first dryer; and
printing the second web on a second web second side downstream of the first dryer.

13. The method as recited in claim 12 wherein the first web first side is printed by a satellite printing press.
